(19) United States
(12) Patent Application Publication
(10) Pub. No.: US 2026/0225256 A1
(43) Pub. Date: Aug. 6, 2026

(54) HYBRID APPROACH TO PERFORM DYNAMIC PROJECTION MAPPING ONTO ROBOTIC FIGURES IN REAL-TIME

(71) Applicant: DISNEY ENTERPRISES, INC., Burbank, CA (US)

(72) Inventors: Alfredo Medina Ayala, West Covina, CA (US); Joel Jason Peavy, Poway, CA (US); Prutsdom Jiarathanakul, Glendale, CA (US); David Powell Goldberg, Altadena, CA (US); Bryan S. Tye, Canyon County, CA (US)

(21) Appl. No.: 19/448,327

(22) Filed: Jan. 14, 2026

Related U.S. Application Data
(60) Provisional application No. 63/755,000, filed on Feb. 6, 2025.

(51) Int. Cl. B25J 11/00; B25J 9/10; H04N 9/31

(52) U.S. Cl. CPC B25J 11/0015; B25J 9/1085; H04N 9/3185

(57) ABSTRACT

Systems, methods and apparatuses for a hybrid approach to perform dynamic projection mapping onto robotic figures in real-time are discussed herein. For example, a robotic system may include a continuous projection surface coupled to a structure. The robotic system may further include an actuator coupled to the structure that is configured to change a topography of a portion of the continuous projection surface. The robotic system may further include a projector positioned relative to the continuous projection surface that is configured to project content onto the continuous projection surface. In some cases, the robotic system may align a projection surface with a projector, wherein the projection surface defines a continuous projection screen over the robotic structure, actuate a mechanical movement of the projection surface to change a topographical shape of the projection surface, and project a content specific to the change of the topographical shape.

### CROSS REFERENCE TO RELATED APPLICATIONS

The present application is related to and incorporates by reference U.S. Non-Provisional patent application Ser. No. 19/407,596 filed on Dec. 3, 2025, and titled “DYNAMIC MECHANICAL SKIN STRUCTURES FOR ANIMATRONIC FIGURES” and U.S. Non-Provisional patent application Ser. No. ______ [Attorney Docket Number P322674.US.03] titled “HYBRID APPROACH TO PERFORM DYNAMIC PROJECTION MAPPING ONTO ROBOTIC FIGURES IN REAL-TIME” filed on Jan. 14, 2026, for all purposes. Additionally, the present application claims priority to U.S. Provisional Patent Application No. 63/755,000 filed on Feb. 6, 2025, and titled “Hybrid Approach to Perform Dynamic Projection Mapping Onto Animatronic Figures in Real-Time,” which is herein incorporated by reference in its entirety.

### FIELD

The present disclosure relates generally to systems and methods for controlling and implementing robotic devices, such as animatronics.

### BACKGROUND

Amusement parks, theme parks, carnivals, arcades, and various attractions use robotic devices, such as animatronics, to produce an interactive effect for guests. For example, animatronics mimic the movement, look, and emotion of characters sharing the theme of the rides, shows, and games, and can interact with guests to provide a truly immersive experience. Additionally, other types of robotic devices appear in everyday life such as in food service environments, manufacturing environments, and social interaction environments, interacting with users and the environment.

Traditional animatronics use mechanical actuators to animate or move different portions of the robotic device, e.g., an animation including movement of an arm includes mechanically moving an appendage of the animatronics. However, such mechanical motions are limited by mechanical constraints, space constraints, and wear rapidly over time. Further, such motions look unrealistic as they are often large and slow motions that are not realistic in appearance.

### SUMMARY

In one embodiment, a robotic system is disclosed. The robotic system includes a a continuous projection surface coupled to a structure. The robotic system further includes an actuator coupled to the structure and configured to change a topography of a portion of the continuous projection surface. The robotic system further includes a projector positioned relative to the continuous projection surface and configured to project content onto the continuous projection surface.

Optionally, in some embodiments, the structure defines a recess and the continuous projection surface extends over the recess to define a projection area over the recess.

Optionally, in some embodiments, the actuator moves the structure to cause the continuous projection surface to define a concave section for the projection area over the recess.

Optionally, in some embodiments, the actuator is configured to expand the portion of the structure and the continuous projection surface extends over the portion to enable definition of a projection area over the portion.

Optionally, in some embodiments, the projector is spatially aligned with the continuous projection surface such that the content is aligned with changes in the topography as the actuator moves the continuous projection surface, and the content is time aligned with the actuator such that the actuator moves the topography based on the content.

Optionally, some embodiments further comprise a sensor in communication with the projector and configured to detect a position of the actuator or the continuous projection surface.

Optionally, in some embodiments, the robotic system further comprises a controller, wherein the sensor is in communication with the projector via the controller.

Optionally, in some embodiments, the sensor is external to the structure.

Optionally, in some embodiments, the sensor is internal to the structure.

Optionally, in some embodiments, the actuator is configured to move the continuous projection surface to generate a first type of output and the projector projects content to generate a second type of output, wherein the first type of output and the second type of output together generate a robotic device output.

Optionally, in some embodiments, the robotic system further comprises a scenic element, wherein the scenic element enhances the robotic device output.

Optionally, in some embodiments, the robotic system further comprises a sound element, wherein the sound element enhances the robotic device output.

In another embodiment, a method of activating a robot is disclosed. The method includes actuating a mechanical movement of a projection surface positioned over an robotic structure to change a topographical shape of a portion of the projection surface, wherein the projection surface defines a continuous projection surface over the robotic structure. The method further includes projecting, by a projector, a content specific to the change of the topographical shape on the projection surface. The method further includes detecting a position of the mechanical movement of the projection surface, a position of the projection surface, or a combination thereof. The method further includes providing feedback to a controller regarding the position of the mechanical movement of the projection surface, the position of the projection surface, or the combination thereof, the change of the topographical shape, and the content. The method further includes modifying the content based on the feedback.

Optionally, some embodiments further comprise aligning the projection surface with the projector based on the feedback.

Optionally, in some embodiments, the feedback comprises feedback intrinsic to the robot, feedback external to the robot, or a combination thereof.

Optionally, in some embodiments, robotic structure defines a recess or aperture, and the projection surface extends over the recess or aperture to cover the recess or aperture.

In another embodiment, a non-transitory computer-readable media comprising instructions is disclosed. The non-transitory computer-readable media comprising instructions causes a robot to actuate a mechanical movement of a mouth feature of a projection surface positioned over a robotic structure to change a topographical shape of the mouth feature of the projection surface, wherein the projection surface defines a continuous projection surface over the robotic structure. The non-transitory computer-readable media comprising instructions further causes the robot to project, by a projector, a content specific to the change of the topographical shape on the mouth feature of the projection surface. The non-transitory computer-readable media comprising instructions further causes the robot to detect a position of the mouth feature of the projection surface. The non-transitory computer-readable media comprising instructions further causes the robot to provide feedback to a controller regarding the position of the mouth feature of the projection surface, the change of the topographical shape and the content. The non-transitory computer-readable media comprising instructions further causes the robot to modify the content based on the feedback

Optionally, in some embodiments, the instructions further cause the robot to align the mouth feature of the projection surface with the projector based on the feedback.

Optionally, in some embodiments, the feedback comprises feedback intrinsic to the robot, feedback external to the robot, or a combination thereof.

Optionally, in some embodiments, the robotic structure defines a recess or aperture, and the projection surface extends over the recess or aperture to cover the recess or aperture.

### BRIEF DESCRIPTION OF THE DRAWINGS

FIG. 1 illustrates a simplified schematic of a system for performing dynamic projection mapping onto animatronics in real-time.

FIG. 2A illustrates an example animatronic with a continuous projection surface positioned over a robotic structure of the animatronic.

FIG. 2B illustrates an example of a continuous projection surface of an animatronic modified to align with content projected onto it.

FIG. 2C illustrates an example of a continuous projection surface of an animatronic and a continuous projection surface of an animatronic modified to align with content projected onto it.

FIG. 3A illustrates a cross section side view of a continuous projection surface with an actuator that is at rest.

FIG. 3B illustrates a cross section side view of a morphed continuous projection surface with an activated actuator.

FIG. 4 illustrates a cross section side view of a continuous projection surface with example mechanical means for modifying the topography of the continuous projection surface.

FIG. 5 is a system diagram used for performing dynamic projection mapping onto animatronics.

FIG. 6 illustrates a method of activating an animatronic.

FIG. 7 illustrates a functional block diagram of an animatronic design system of an animatronic operable or controllable according to the hybrid approach discussed herein.

FIG. 8 illustrates a simplified block diagram of components of a computing system of the system of FIG. 1.

### DETAILED DESCRIPTION

Embodiments herein introduce a system and method for animating a robotic device, such as an animatronic. Portions of the animatronic may be animated, such as animation of a portion of a face, limb, or other element of the animatronic. It should be noted that while many embodiments described herein are with reference to an animatronic, the embodiments are equally applicable to other types of movable systems, such as other robotic devices. Therefore, the term “animatronic” is not meant to be limiting. The animation includes a hybrid approach using mechanical actuators combined with content projection, where the content is projected onto a continuous projection surface of the animatronic (e.g., an outer covering or skin of the animatronic).

The mechanical system mechanically actuates portions of the animatronic, e.g., allowing portions of the continuous projection surface to be moved and deformed. The content projection enhances and supplements the mechanical motion. For example, animation, detailed realism, special effects, and artistic elements of facial features, including, but not limited to, skin texture, color, macro and micro animations, wrinkles, cinematic effects, visual effects (VFXs), etc. are projected along with mechanical motion representative of the same animated effect. The overall effect of the mechanical motion and projected content creates a realistic and immersive experience not possible to generate solely with mechanical motion. The combination of topography changes (e.g., via mechanical motion) with the content projection over the same surface of the animatronic introduces realism and allows more complex and detailed animations for the animatronic, many of which would not be possible to create with just mechanical motion, such as finer or faster motions that cannot be done with mechanical actuators. The animation of the animatronic includes various human or non-human facial features, expressions, emotions, motions, and other content of the sort that an animatronic is to perform or represent. In short, the content projection enhances bulkier movement of the mechanical portions of the projection surface of the animatronic to generate effects not possible with conventional techniques.

In some embodiments, a position, orientation, or pose of the animatronic is tracked or otherwise identified using a combination of one or multiple tracking or position identification methods. In many instances, the orientation may be tracked in real-time to ensure alignment and accurate projection between the projected content and the mechanical movement of the projection surface. For example, the tracked pose of the animatronic is used by a real-time rendering engine to render a desired image (e.g., desired artistic content) to be projected onto the animatronic by one or more projectors based on the position (e.g., topography, deformation, pose) of the features of the projection surface. By helping to avoid misalignment between the content and the motion, the realism is enhanced, whereas misalignment will detract from the realism.

As compared to conventional methods, the realistic appearance is enhanced by increased fidelity and detail of the content. Further, the projected content contains more degrees of freedom than possible in traditional animatronics. In some embodiments, the animatronic may be animated more consistently compared to traditional animatronics as a number of artistic elements within the projected content, e.g., color, motion, smoothness, etc., will be the same even if the mechanical components or skins are changed over time (e.g., actuators slow or skin colors change). In some examples, the skins or other coverings defining the projection surfaces for the animatronics do not need to deform as much (e.g., can have a shorter/smaller range of motion) as compared with traditional animatronics. As a result, the lifespan of such skins or other coverings may last much longer as compared to traditional animatronics. Additionally, in some cases, special effects may be employed for the content of the animatronic that are not possible using traditional techniques, such as enabling animated figures to blush, cry, or be animated to perform any other effects that can be projected.

In some embodiments, multiple considerations on designing the topography of the face of the animatronic (or any other part of the animatronic) may be introduced. For example, instead of using a traditional animatronic face with functions that move skin, in some embodiments, facial functions may be designed that morph the skin topography to serve as a projection surface and ensure continuity of a projection surface. For example, the mouth of the animatronic may not be a physical mouth aperture, but rather the face skin can stretch over the mouth aperture or recess (e.g., as a mouth bag), and the projected content may define the image of the inside of the mouth with teeth and a tongue. The mouth bag may move (e.g., via an actuator) to deform the topography of the projection surface to showcase the mouth and any motion and movement that may be performed by the mouth. The continuous projection surface helps to ensure that the content has a surface onto which it can be projected. As another example, eyebrow functions of the animatronic may morph the topography of the skin of and around the eyebrows (e.g., push out the skin, slide the skin up/down, tilt the skin) to create an embossment in the shape of the eyebrow in the desired position. In some examples, extra material may be included in the continuous projection surface in areas where the continuous projection surface may need to be extensively manipulated or deformed to match an intended character or emotion (e.g., a longer nose, horns, or a defined larger chin).

In various cases, the continuous projection surface may be made of silicon as silicon may elastically deform via actuators or other mechanical means while being able to return to the original shape, thereby reducing the risk of tearing. Additionally, silicon may allow for the embedding of attachment points (e.g., attachment to actuators, or attachment to the animatronic), while still retaining the ability to elastically deform. In various other cases, the continuous projection surface may be made up of different materials such as neoprene, latex, cloth, elastomers (e.g., self-healing or liquid crystal), etc. Said materials may be used in combination with the silicon or in combination with one another to make up the continuous projection surface. In some examples, the continuous projection surface may include different surface finishes depending on the intended implementation of the animatronic. For example, a matte finish may be used for dramatic emotional implementations, while a reflective finish may be used for cartoony implementations. In some examples, the continuous projection surface may include different thicknesses across the continuous projection surface to allow for more deformation or for less deformation in specific portions of the continuous projection surface to better match the intended character or emotion. Additionally, the difference in thicknesses across the continuous projection surface may allow for different projections to show up better on certain thicknesses of the continuous projection surface. For example, a projection with a stronger and bolder intended emotion may show up better on a thicker continuous projection surface, whereas weaker intended emotions (or small intended emotional changes) may show up better on a thinner continuous projection surface.

In various embodiments, two or more continuous projection surfaces may be used in combination for one animatronic. For example, a first continuous projection surface may be used for a face of the animatronic and a second continuous projection surface may be used for the neck of the animatronic. In another example, a first continuous projection surface may be used for the face of the animatronic and a second continuous projection surface may be used for the gills or the ears of the animatronic. Note that the first continuous projection surface may be used for other features of the animatronic and is not limited to the face of the animatronic.

In various embodiments, the continuous projection surface may be or coupled to the animatronic (e.g., a shell portion of the animatronic) as to allow for the deformation of the continuous projection surface while not impacting the final topography of the deformed continuous projection surface. In some instances, anchors may be used to couple the continuous projection surface to the animatronic such as anchors that attach to the shell or anchors that snap onto the shell. In some instances, magnetic anchors may be used to couple the continuous projection surface to the animatronic. In some instances, anchors may be manufactured into the continuous projection surface (e.g., embedded) and not positioned/added to the continuous projection surface after the manufacturing of the continuous projection surface.

The hybrid procedure for morphing of the skin topography to serve as a projection surface discussed may be combined with traditional methods of moving an animatronic. For example, conventional actuators may be used to turn the head of the animatronic (e.g., left and right), while the skin of the head may be morphed according to embodiments herein to move features of the head (e.g., eyebrows, wrinkles, nose features, mouth features, etc.) in a certain way.

It should be understood that the hybrid design of the topography of the face of the animatronic can apply to any other function that may need to morph and deform the skin into a desired shape for the projection. Note that appropriate designs may vary depending on the character mimicked by the animatronic and the intended content to be performed by the animatronic.

Portions of the face of the animatronic that do not move may be given additional consideration. For example, traditional animatronics use large amounts of surface detailing in the face, however embodiments herein use a hybrid projection face with limited surface detailing. Traditional animatronics include certain details (e.g., molded areas of the covering) that may create deep creases and crevices in the face skin topography that would occlude light, e.g., create shadows or prevent accurate projection onto the surface. Additionally, in traditional animatronics, the more defined a facial detail is, animatronics the less flexible the facial detail is for a dynamic projection content that needs to animate and change over the top of it. Embodiments herein include smooth projection surfaces on specific parts of the continuous projection surface of the animatronic that will be needed for content and parts that are sensitive to light occlusion. As a result, the animatronic may be flexible for content.

In some instances, a machine learning model may be trained with one or more feedback loops and process refinements to make decisions that impact surface projection topography that optimize smoothing of the continuous projection surface of the animatronic and avoid casting shadows on the animatronic.

In some embodiments, various methods may be used to morph the topography of the projection surface (e.g., a face) of the animatronic. Morphing the topography of the projection surface of the animatronic may be understood as defining concave section(s) of the projection surface to emphasize features that will be projected on. In some cases, an electromechanical actuation, such as motors and other types of electric actuators, may be used to morph the topography of the projection surface of the animatronic. For example, actuators (or motors) may be linked to the topography of the projection surface of the animatronic using a rigid link, using pneumatic tubing, or using tensile element linkage. The morphing of the topography of the projection surface of the animatronic is further detailed U.S. Non-Provisional patent application Ser. No. 19/407,596 filed on Dec. 3, 2025, and titled “DYNAMIC MECHANICAL SKIN STRUCTURES FOR ANIMATRONIC FIGURES,” which is herein incorporated by reference in its entirety.

In some other cases, different fluids or gasses may be used to move the skin adjusting the topography of the face or projection surface (e.g., in bags placed underneath the continuous projection surface). In yet some other cases, combinations of chemical or electrochemical actuation may be used to adjust the topography of the face or projection surface of the animatronic. In yet some other cases, geometric lattice optimization and design may be used to form certain desired shapes when deformed, in some examples, with the other procedures for morphing the topography of the face or the projection surface of the animatronic. In yet some other cases, linear pneumatic actuators may be used to adjust the topography of the face or projection surface of the animatronic. In yet some other cases, a shape memory alloy may be used to adjust the topography of the face or projection surface of the animatronic. Additionally, gradient material properties design may be used to adjust the topography of the face of projection surface of the animatronic. It should be understood that a combination of the discussed procedures can be used together by mixing algorithmic and procedural methods for dynamic topography optimization for projection.

Embodiments herein may lower the design and fabrication costs of the mechanical face of the animatronic, as there are fewer mechanical functions (e.g., such as actuators) for the simplified face using the continuous projection surface. Additionally, embodiments herein may lower the maintenance cost of the animatronic as there are fewer components that may break down. Moreover, in some embodiments, the design of the skin of the animatronic is a continuous projection surface in that the skin may not include apertures, which traditionally define stress points that rip and tear over time, such as eye apertures or the corners of the mouth. Such a configuration helps to reduce wear and tear on the skin of the animatronic, increasing life span of the skin of the animatronic and the animatronic itself. Further, embodiments herein increase the viewing angle and realism of the animatronic as the continuous projection surface may wrap around the animatronic and the proportions of the animatronic with the continuous projection surface may remain the same. Accordingly, from the side or from the back, the animatronic may still look as the intended character/implementation, whereas traditional animatronics may look robotic and unnatural due to different surfaces, apertures, as one looks around a traditional animatronics (e.g., side and back views).

In some implementations, it may be that the animatronic figures with the continuous projection surface and mechanical face may exist in a scene including set lighting. For example, animatronics may be placed in themed scenes that are illuminated by theatrical lighting (e.g., ellipsoidal(s), follow-spot(s), Fresnel(s), PAR Can(s), floodlight(s), Cyc Light(s), strip light(s), gobos,) and special effect elements that include fiberoptics, projection, blacklight, and/or phosphorescent etcetera. The theatrical or scenic lighting may be used to illuminate the animatronics, sets and props so the users experiencing the animatronic can clearly see everything they are meant to see onstage (e.g., intended emotions and performed actions). However, in some cases, it may be that the scene is illuminated while the animatronic(s) are also illuminated. Note that the lighting of the animatronic is not exclusive, but rather a combination of both primary projection lighting and secondary scenic object lighting. For example, secondary scenic object lighting is light that bounces off scenic objects, resulting in unwanted illumination of the animatronic(s) in the scene. The amount and type of reflected light may depend on the light saturation, hue, and intensity, as well as the animatronic's texture or smoothness and other material intrinsic optical properties. Therefore, the primary projection lighting from the projection may take into account (e.g., when being generated) the lighting of the scene to seamlessly integrate and blend in as part of the environment.

In some embodiments, virtual cinematic lighting generated digitally in the rendering engine may be combined with practical theatrical lighting in the scene to achieve creative intent and avoid conflict between the two different light sources onto the animatronic and the scene around the animatronic. A material that accounts for the reflections of the secondary scenic lighting that may light the animatronics may be used. For example, this may be a material that is dynamic to capture changes in the scene. The combination of the cinematic lighting with the theatrical lighting may be achieved by virtually modeling the physical light environment into a rendering engine and by using a combination of both discrete lights, projected lighting, and high dynamic range image (HDRI) environment light captured from the scene to accurately model the scene.

A virtual figure may be positioned in a virtual lighting environment to render a projected image. As the animatronic moves or changes orientation through the physical space, the virtual figure is tracked and also moves through the virtual space. Accordingly, the lighting that interacts with the material on the virtual figure changes, which is then rendered out through the projector and projected back onto the animatronic. This results in the animatronic reacting to the lighting in the same scene. Conversely, the lighting in the scene can change dynamically, and may be reflected and modeled accurately in the virtual environment, either through physical or digital triggers or sensors. This change in lighting may be displayed on the virtual figure that is rendered and projected back onto the physical figure. In some instances, micro lighting may be included to address orifice lighting needs to achieve creative intent. This lighting may be dynamic to blend the real world with the virtual world.

In some embodiments, the system for animating the animatronic may include animatronic tracking. For example, the system performance of the system may be based on the accuracy of the tracking. Faster tracking accuracy, speed, and reduced latency of the animatronics assist to ensure that the content is aligned and therefore more realistic. In some instances, tracking the dynamic poses of the animatronic includes using feedback data from the animatronic. The tracking of the dynamic poses of the animatronic includes using, for example, motor encoder positions, passive encoders, sensors, motor torques, currents, accelerations, velocities, various other types of encoders, rotaries, linear variable differential transformers (LVDTs), resolvers, etc. In many instances, the data is read and processed in real-time. The processing of the data may include computing joint rotations, and reconstructing the kinematics model of the animatronic. As a result, the processed data predicts joint positions and rotation. The tracked pose is used by the rendering engine to position the projected content onto the animatronic. The intrinsic tracking procedure includes an accurate alignment and fabrication of the physical animatronic to match the virtual model representation. Many embodiments may not need an external tracking system, instead relying on intrinsic tracking, allowing much faster feedback and processing speeds (e.g., many external tracking systems have a speed of about a couple hundred hertz, whereas intrinsic tracking used according to embodiments herein runs as fast as motor control systems (e.g., around a couple thousand hertz)).

Additionally, in some embodiments, with external tracking related to inertial measurements, it may be that in many cases orientation data and positional data of an object may need to be acquired. To achieve a high accuracy of real-time rotary data per object for animatronic sync projection, intrinsic tracking with internal measurement units (IMUs) may be introduced. It should be understood that a high accuracy may be needed to achieve meaningful projection of real-time assets back to animatronic heads, bodies, and body parts.

In some instances, traditional animatronics exhibit mechanical inaccuracies due to build tolerances, mechanical slop, or backlash due to wear and tear. These inaccuracies cannot be captured by internal motors and encoders alone, and other measurements may be needed.

In some embodiments, a combination of intrinsic or camera-based tracking and IMU systems may be used. Such embodiments may achieve multiple data sources for position data and orientation data. As a result, this may allow the use of a broad selection of tracking systems beyond intrinsic tracking, such as camera-based tracking. In some instances, the system can deal with temporary occlusions, using the displacement information from the IMU as position indicator. It should be understood that animatronics experience wear and tear over time, which reduces the accuracy of the movements and the content and can introduce downstream errors in tracking and alignment of the content. For example, movements not captured by motor encoders may not be tracked by intrinsic tracking. In some cases, this may occur because of mechanical backlash, play, or slop.

In some embodiments, IMUs can be added to select joints in the animatronic. Instead of using motor encoders to determine relative joint rotations, the IMU rotational values of specific joints may be used to determine joint rotations relative to ground. This can then be used in a similar manner to reconstruct the kinematics model of the animatronic, in order to ultimately determine the entire position and rotation pose of the animatronic.

Consider an example where the head of the animatronic is to be tracked, and the head is a three degrees of freedom (DOF) function driven by three different motors for each DOF. According to embodiments herein, one or more IMUs may be placed in the head and the orientation information of the IMUs can be deconstructed into Euler rotation angles to determine the rotation angle of each of the three motors.

In some embodiments, to capture mechanical inaccuracies of intrinsic tracking, extrinsic tracking may be used in combination with intrinsic tracking in a sensor fusion manner. Extrinsic tracking includes external cameras that capture the animatronic and optionally include markers, either passive or active, in order enhanced detection or calculation of the position of the object. Extrinsic tracking can determine absolute position and rotation, but may have issues related to stability, noise, and speed. Intrinsic tracking can be fast and accurate, but expensive. In many embodiments, combining the functionality of both intrinsic and extrinsic tracking can be helpful to enhance accuracy, speed, and cost. Sensor fusion algorithms can be used to combine sensor data from different sources so that the result has much less uncertainty than if these sources were used individually.

In some implementations, combining intrinsic tracking and extrinsic tracking may be achieved by using extrinsic tracking to determine the absolute position and rotation of a certain joint, and then using that joint as the base upon which to construct the kinematic chain using intrinsic tracking. This way, intelligent decisions may be made whether to use extrinsic tracking or intrinsic tracking on certain joints which may have some mechanical error. For example, extrinsic tracking may be used on joints that have slop and mechanical error, or drift and intrinsic tracking may be used on joints that are stiff, made of higher quality materials, or have less mechanical error.

Alternatively or additionally, extrinsic tracking may be used not directly on the surfaces of the animatronic itself, but on a separate mechanical part attached to the animatronic. In some instances, it is not possible to put tracking markers on the animatronic itself because of various reasons, such as, hiding the trackers from the view of users experiencing the animatronic, clothing of the animatronic getting in the way, or other mechanical feasibility issues.

In some cases, extrinsic tracking may be used by swapping where the cameras and the markers are attached. For example, the camera may be placed inside the head of the animatronic and the markers may be placed out in the environment around the animatronic. Then, the relative position of the camera to the markers may be used (e.g., inverting the transformation) to determine the pose of the head of the animatronic.

In some embodiments, radio frequency tracking may be used to track the pose of animatronics. Radio frequency tags may be placed on each joint, and radio frequency sensors may be placed in the environment. The pose of the animatronic may be determined from the position and rotation data of each of the tags.

In some embodiments, electromagnetic tracking may be used to track the pose of the animatronic. Electromagnetic receivers can be placed on each joint of the animatronic, and the electromagnetic transmitter may be placed in the environment. The pose of the animatronic may be determined from the position and rotation data of each of the electromagnetic receivers.

In some embodiments, light detection and ranging (LiDAR) tracking may be used to find the animatronic's head's translation and orientation using, for example, laser pulses and measuring the time for object projection. In some cases, one or more single-beam LiDAR sensors may be mounted on the back half of the animatronic's head. A lookup table may be used correlating the reported distance data(s) to animatronic's head pose. For example, when a first LiDAR sensor reads 1.072 m and a second LiDAR sensor reads 1.605 m, the head is at a known XYZ position and a known yaw pitch roll. In some cases, LiDAR may be practically viable for a small range of motion. If the lookup table has redundancies, these can be resolved by proximity.

In some other cases, to avoid needing to know where the head of the animatronic is, two or more “sniper spotter” LiDAR systems may be used. Such systems use high-Hz MicroElectroMechanical system (MEMS) projectors and high-Hz cameras (that can see both visible and infrared (IR)) to feed a control loop that attempts to align the visible projection to two or more IR-emitting key-points on the face. For example, a camera may see that the projected nose tip is incorrectly a certain distance left of the IR nose point. This error is fed into a control loop that corrects such error. Multiple reference points are used to achieve rotation/warp. Additionally, distance is never calculated or known by any part of the system. Rather, the system tries to keep two images (one visible, one IR) in alignment constantly. LiDAR can also be used to create a point cloud of a certain part of the figure, such as the face, which can then be registered against another predetermined known point cloud of the same part. This registration can then be used to determine the pose of that part of the animatronic.

In some embodiments, structured light scanning can be used to create a point cloud of a certain part of the animatronic, such as the face, which can be registered against another predetermined known point cloud of the same part. This registration can then be used to determine the pose of that part of the animatronic.

In some embodiments, IR activated coating pigments applied to a projected surface that exhibit, for example, IR down conversion, IR up conversion, anti-stokes shift, or black visible IR (e.g., black or clear) may be used to create markers for use in camera-based tracking. For example, such methods may shift/convert wavelength emission for measuring to generate various positional and movement data. In some cases, an up or down conversion coating may be used in a dot pattern and the system may initiate an up down fluorescence shift with an excitation source. Accordingly, a camera may capture such pattern and use it for tracking. In some other cases, an up or down conversion coating may be used in a unique AprilTag pattern, and the system may initiate an up down fluorescence shift with an excitation source. Accordingly, a camera may capture such pattern and use it for tracking. IR coatings are pigments not visible under visible light, but are visible under infrared light. Such paint (e.g., IR coatings) can be used to paint markers for existing off-the-shelf extrinsic tracking systems, or it can be used to paint fiducial markers such as AprilTags for IR cameras to look at and solve for positions. These paints (e.g., IR coatings) can be applied to each joint of the animatronic to determine the pose of the animatronic.

In some embodiments, fiber optic may be used for animatronic pivot tracking. In some cases, fiber optic technology (e.g., RealShape (FORS)) may be integrated into a guide system for the animatronic. FORS-enabled guidewires have a hair-thin optical fiber integrated into them. By pulsing laser light into the fiber and analyzing how it is reflected, the full shape of devices, which are slid over the guidewire, can be reconstructed and visualized. Using deep learning, semi-automatic shape registration of the FORS-enabled guidewire can be integrated into the procedure workflow to extract translation and orientation of a link pivot. In some other cases, shape forming optical elements or direct shape forming optical shapes may be applied on the fiber optics itself. Accordingly, these shapes may be applied onto the front of the projected surface for external camera tracking to compute translation and orientation of the animatronic for tracking. In some examples, small fiber optics carrying IR light can be used on a certain part of the animatronic, such as the face. These fiber optics are too small to be noticed by users experiencing the animatronic and the IR wavelength is invisible, so they can be used directly on the same surface upon which content is projected on the animatronic.

In some embodiments, facial recognition machine learning models may be used for animatronic tracking. For example, a camera may be set up and the camera and the image feed of the camera may be sent to an existing off-the-shelf facial recognition model to recognize the face of the animatronic and provide the system with the estimated pose of the face of the animatronic. This pose can then be used by a rendering engine to transform the content to project back onto the animatronic's face. In some cases, a discriminative shape regression method may be applied to locate the facial feature points on the 2D image and may fuse the 2D data with a 3D face model using, for example, an extended Kalman filter to yield 3D facial movement information with IMU or IR up conversion tagging.

In some embodiments, a machine learning model may be developed and introduced for animatronic head pose estimation for relative front face animatronic orientation and position with respect to an external camera. In some cases, wavelet features on camera captured images and principal component analysis may be used to determine an orientation of an object of interest of the animatronic (e.g., head, arm, leg, wrist, elbow, hand, neck, shoulders, etc.) with principal component analysis coefficients. Then, a Kalman filter may be applied on captured frames. In some other cases, a model base approach based on perspective projection may be used. Geometric features such as eyes, ears, or a nose may be used to track animatronic facial landmarks. In yet some other cases, a combination of wavelet features and the model based approach based on perspective projection may be used. For example, a 3D deformable shape model may be learned using principal component analysis (PCA) methods. Then, a linear combination of an average shape may be applied. In some examples, one or more cameras may be set up in the environment to look at the animatronic. A series of pictures may be taken of the animatronic in different poses, along with recording the 3D position and rotation data of each joint of those poses. This data may be used to train a machine learning model, by providing images of a certain part of the animatronic, such as the face, arms, legs, shoulders, neck, etc., along with the corresponding 3D position and rotation. The result would be a machine learning model that outputs a 3D position and rotation of a part of the animatronic given a camera image from a certain viewpoint.

In some implementations, in addition to standard red green blue (RGB) cameras, depth cameras may be used to augment the received data. The data may be used to solve for the pose of a part or the entire animatronic.

In some embodiments, predetermined geometric shapes placed on the animatronic may be tracked using, for example, a generalized HoughGuil transform to determine the position and orientation of an animatronic or an animatronic's body parts. The tracking of predetermined geometric shapes may be used in combination with IR up conversion, IMU, intrinsic tracking, extrinsic tracking, PCA, Kalman filter, weak perspective procedures, or other procedures for tracking the animatronic discussed herein. In some instances, instead of trying to track and solve for an arbitrary and complex shape that is a part of the animatronic, such as the face, a simpler, known, predetermined, geometric shape may be attached to the part (or embedded in the part) of the animatronic, which would not be visible to the users experiencing the animatronic, such as on the back of the head of the animatronic. The known predetermined shape may be seen by cameras, and the resulting camera image can be used to solve for its 3D pose using simple image processing algorithms. For example, incorporating strips dipped with IR reflective material can be molded into to an intended skin that would hold an intrinsic predetermined shape that may be only visible by IR camera. This will allow for a front projection surface or a secondary back projection surface. To determine its orientation and position, knowing the camera intrinsic parameters (e.g., focal length, optical center) and extrinsic parameters, an edge detection (e.g., Canny edge detector) may be applied to a captured image and then a corner detection algorithm (e.g., a Harris algorithm) may be applied to the capture image. The center of the shape in the capture image may be calculated and the shapes orientation may be determined. Then, intrinsic and extrinsic tracking and object 3D real world referenced coordinates from mechanical model may be used to reference orientation of the object of interest of the animatronic. In various examples, it may be that the predetermined shapes may be visible only in the ultraviolet (UV) spectrum.

In some implementations, radar or sonar may be utilized as means of tracking each joint of the animatronic (or the animatronic as a whole) to determine the pose of the animatronic.

In some embodiments, durometers such as light-emitting diode (LED) durometers or skin durometers may be positioned onto the animatronic or embedded into the animatronic as to the track the animatronic and its movements. The durometers may detect light or other waves (e.g., IR and/or UV) and calculate the position and/or movement of the animatronic. In some cases, a fiber optic LED coupler may be used in combination with the LED durometers and/or skin durometers.

In some embodiments, the animatronic is tracked in real-time. As such, the lower the latency of the system, the more accurate the results of the projection are as to provide the illusion that the projection appears stuck or painted onto the animatronic surface. However, the processing, rendering, and projection may take time, introducing some delay and/or latency. However, the delay/latency may be compensated by prediction. For example, in some embodiments, the time it takes for the system to process a single frame, end-to-end, from tracking to projection may be measured. The motion and the pose of the figure may be predicted into the future for that exact time. The projection is rendered to the predicted pose of the animatronic, so that by the time the system is done processing, the projection ends up to where the animatronic would be in time. In some cases, the latency of the system is within tens of milliseconds, so the prediction does not need to be very far into the future. At this relatively small timescale, real-world objects obeying the laws of physics tend to behave in a relatively smooth and continuous manner, so physics simulations may be used to accurately predict the motions.

In some tracking methods discussed herein, an accurate kinematic model of the animatronic was created. However, such predictions methods may be used in combination with the tracking methods. For example, a dynamic model of the animatronic may be created with all the physical properties such as mass, center-of-mass, etc. The dynamics properties of the physical figure may be measured and calculated in real-time, such as velocity, acceleration, torques, and more. Then, this information may be combined to run a physics simulation of the animatronic to predict the pose of the animatronic into the near future. Moreover, in cases where the animatronic performs a known movement, command information may also be used as additional input to the physics simulation to improve the prediction results.

Alternatively or additionally, a machine learning model may be trained to perform motion prediction. For example, the machine learning model approach discussed herein may be expanded and trained to perform motion prediction. In addition to providing the static pose information, the entire kinematic and dynamic model of the figure may be provided to the model, along with the current dynamic information such as velocity and acceleration with respect to time. The result of the machine learning model is a time-based machine learning model that can predict where the pose of the figure would be in the specified time in the future given the current real-time dynamic information.

It should be understood that any of the tracking procedures discussed herein may be used independently or combined with one another to track a position and/or orientation of the animatronic.

Note that embodiments herein allow for the continuous aligning of the movement of the content projected onto the animatronic with the movement of the continuous projection surface of the animatronic even if an actuator or a motor of the animatronic fails/breaks. For example, the tracking procedures discussed herein may still provide data corresponding to the animatronic to the controller if an actuator breaks, allowing the controller to align the projected content with the animatronic (with the broken actuator). As a result, the animatronic with the broken actuator or motor is less noticeable.

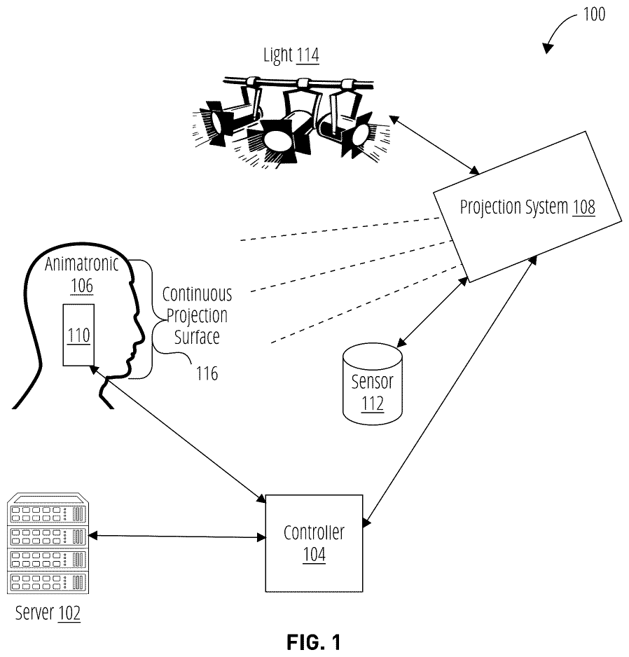

Turning to the figures, FIG. 1 illustrates a simplified schematic of a system 100 for performing dynamic projection mapping onto animatronics in real-time.

The system 100 for performing dynamic projection mapping onto animatronics includes a server 102, a controller 104, an animatronic (hereinafter “animatronic”) 106 (including an actuator 110), a projection system 108, one or more sensors (hereinafter “sensor”) 112, and one or more lights (hereinafter “lights”) 114.

The animatronic 106 may include one or more continuous projection surfaces 116 onto which content may be projected. The continuous projection surface 116 may be a surface covering at least a portion of the animatronic, e.g., a head of the animatronic 106 or any other part of the animatronic 106 desired to be animated. For example, the continuous projection surface 116 may be a skin of the animatronic, where the skin does not include any apertures therein, e.g., a unitary structure. The continuous projection surface 116 may cover multiple moving surfaces of the animatronic 106. The animatronic 106 may receive mechanical inputs from the controller 104 and performed by one or more actuators (hereinafter “actuator”) 110 as to change the topography or otherwise deform the continuous projection surface 116. This may be achieved using the actuator 110, or by using motors, or any other mechanical means connected to the continuous projection surface 116 of the animatronic 106. In many embodiments, the actuator 110 is positioned beneath or behind the continuous projection surface 116 to move it from behind and acts to deform or create ridges, recesses, or the like to the surface. Additionally, the projection system 108 may project content onto the continuous projection surface 116 of the animatronic 106.

The projection system 108 may receive data from the controller 104. The data corresponds to content that is to be projected onto the animatronic 106. The projection system 108 may project the content onto the animatronic 106. The projection system 108 may include a projector (or more than one projector) having a lens system configured to control the image quality and/or magnification. The projection system 108 may optionally include one or more mirrors and/or one or more filters. In some cases, the projection system 108 may adjust what content is being projected onto the animatronic 106 or how the content is being projected onto the animatronic 106 to better align the projection of the content with the continuous projection surface 116 of the animatronic 106. This may be achieved through the use of the sensor 112 that may collect data pertaining to the animatronic 106 and lights 114 that may illuminate the animatronic 106. The collected data may be understood as data collected from tracking the animatronic 106 via the sensors 112 using any of the tracking procedures discussed herein. Note that the projection system 108 may be made up of one or more projectors and various different projectors (e.g., light, lasers, video, environmental projectors, etc.) that may be used in combination to achieve the projection of content onto the animatronic 106.

In some cases, the controller 104 may receive data from the animatronic 106 (e.g., topography, position, orientation, movement data) and from the projection system 108 (e.g., content based data, data on the content is being projected, for example, the sensors 112 and the lights 114). Additionally, the controller 104 may receive data collected by the sensors 112 corresponding to the animatronic 106 (e.g., data corresponding to tracking the animatronic 106). The controller 104 may use such data (e.g., feedback) to align the continuous projection surface 116 of the animatronic 106 and the content being projected by the projection system 108. Additionally, the controller 104 may transmit such data received from the animatronic 106 and the projection system 108 to the server 102 for storage or for use in future implementations or, in some cases, model training. The controller 104 may receive, from the server 102, previous data obtained from the animatronic 106 and the projection system 108 to better align the continuous projection surface 116 of the animatronic 106 and the content being projected by the projection system 108. The controller 104 may transmit mechanical movements to the animatronic 106 to be performed by the actuator 110 (or actuators 110) that may be used to adjust the topography of the continuous projection surface 116 of the animatronic 106. The controller 104 may transmit content to the projection system 108 to be projected by the projection system 108 onto the continuous projection surface 116 of the animatronic 106. Note that the mechanical movement parameters to adjust the topography of the continuous projection surface 116 of the animatronic 106 may be inputted into the controller 104 by a user. Additionally, the content that is to be projected onto the animatronic 106 by the projection system 108 may be inputted into the controller 104 by a user or modified by the user to better align with the actuators 110 of the animatronic 106. The modification may take the form of modifying the timing of the content, modifying the lighting intensity and colors of the content, and/or modifying intended emotions/movements to be performed by the animatronic 106 via the actuator 110.

The server 102 may transmit stored data to the controller 104 and/or receive data from the controller 104 for storage corresponding to the animatronic 106 (e.g., topography, position, orientation, movement data) and to the projection system 108 (e.g., content based data, data on how the content is being projected from, for example, the sensors 112 and/or lights 114). In some examples, this data may be used for future implementations and/or model training.

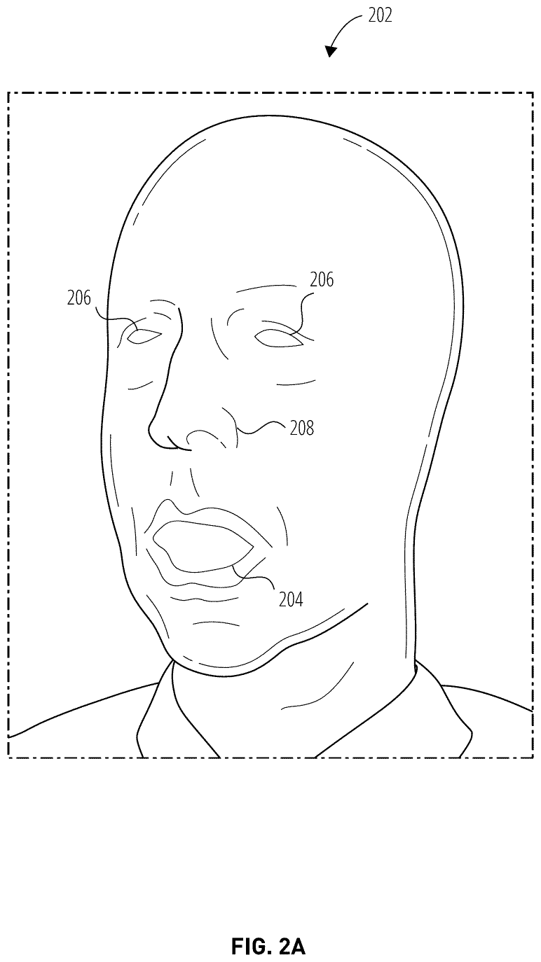

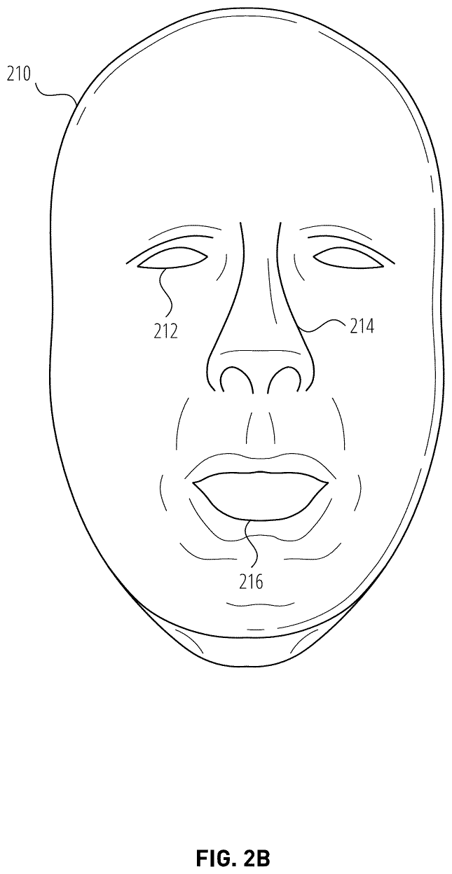

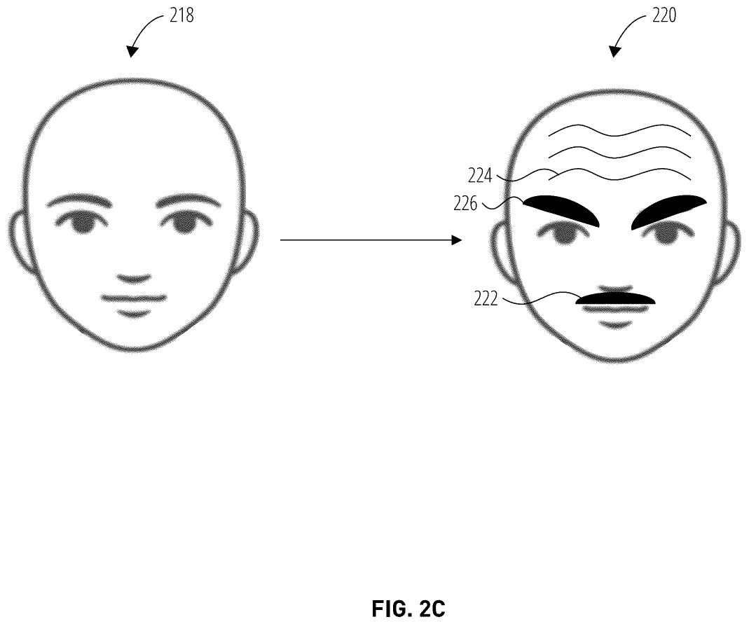

FIG. 2A illustrates an example animatronic with a continuous projection surface 202 positioned over a robotic structure of the animatronic.

In some embodiments, a continuous projection surface 202 may be positioned over a robotic structure of, for example, the head of the animatronic (such as the continuous projection surface 116 positioned over the animatronic 106 illustrated in FIG. 1). The continuous projection surface 202 may include various shallow recess or depression resembling features such as a shallow recess for a mouth 204, shallow recesses for eyes 206, and a shallow recess for a nose 208. The shallow recesses of the mouth 204, the eyes 206, and the nose 208 are continuous with no apertures, tears, or openings as compared to deep recesses with apertures and openings used in current animatronic systems. The shallow recesses of the mouth 204, the eyes 206, and the nose 208 may allow for topographical mechanical changes on the surface and the continuous projection surface 202. For example, the shallow recesses form slack in the continuous projection surface 202 that allows the continuous projection surface 202 to be more readily formed into various shapes, e.g., pulled back to define a cavity for a mouth or pushed forward to define eyebrows or the like. The amount of excess or slack for the continuous projection surface 202 depends on the desired features to be formed with the surface, as well as the flexibility of the continuous projection surface 202 material. The continuous projection surface 202 material may include one or a combination of silicon, neoprene, latex, cloth, and/or elastomers (e.g., self-healing or liquid crystal).

In some instances, the continuous projection surface 202 does not initially include shallow recesses and is only a continuous projection surface 202 with no apertures, tears, or openings positioned over a robotic structure of, for example, the head of the animatronic. Accordingly, the actuators (or other mechanical elements) may be used to manipulate (e.g., morph) the continuous projection surface 202 to include/display the various shallow recess resembling features such as the shallow recess for the mouth 204, shallow recesses for the eyes 206, and the shallow recess for the nose 208. Many conventional animatronics will have separate skin pieces that form a portion of the animatronic and will have openings, such as the mouth, ears, eyes, to allow other secondary elements to be inserted and used to form the animatronic effect. On the contrary, the present embodiments allow a single element, e.g., the continuous projection surface 202, to be sufficiently manipulated to form these different elements and can change between convex and concave shapes to easily transform into different aesthetic features.

FIG. 2B illustrates an example of a continuous projection surface 210 of an animatronic modified to align with content projected onto it.

In various embodiments, topographical mechanical changes (made by mechanical means discussed herein) on the surface of the continuous projection surface 210 allows the continuous projection surface 210 to be formed into various shapes. For example, the continuous projection surface 210 may be pulled back to form eyes 212, the continuous projection surface 210 may be pushed out to form a nose 214, and the continuous projection surface 210 may be pulled back to form a mouth 216. The topographical mechanical changes may be achieved by activating actuators (e.g., such as the actuator 110 illustrated in FIG. 1) that are attached to the continuous projection surface 210. It should be understood that the actuator is attached to the continuous projection surface 210 behind the continuous projection surface 210 (e.g., in the animatronic) and manipulates the continuous projection surface 210 by either moving the shallow recesses of the continuous projection surface 210 or the continuous projection surface 210. For example, an actuator may push, pull and stretch the shallow recess corresponding to the mouth 216, mimicking movement of a mouth. In another example, an actuator may push the middle of the shallow recess corresponding to the mouth 216 to mimic a tongue. Note that one or more actuators (or other mechanical elements) may be connected (coupled) to each shallow recess, or each portion of the continuous projection surface 210 to manipulate the shallow recesses themselves and/or to manipulate the continuous projection surface 210 as a whole.

FIG. 2C illustrates an example of a continuous projection surface 218 of an animatronic and a continuous projection surface 220 of an animatronic modified to align with content projected onto it.

In some embodiments, an animatronic may include a continuous projection surface 218, such as a blank or content free surface, with minimal texture (e.g., similar to a projection screen) where content is to be displayed/projected on. This may be the head of the animatronic or any other body part of the animatronic where content is to be displayed/projected onto. For example, the continuous projection surface 218 may be wrapped around a structure forming a face of the animatronic and may include basic simplistic facial details, such as simplistic mouth, eyes, nose and eyebrow impressions. Note that the continuous projection surface 218 has no apertures, openings, or tears in it (including in areas of facial details such as the mouth, eyes, nose, ears and hair), as it is a continuous surface and extends over the mouth aperture to cover the aperture in the animatronic shell (in embodiments where there is such an aperture).

The continuous projection surface 218 wraps fully or in part over a structure that includes actuator(s) (e.g., actuator 110) or any mechanical means to move the continuous projection surface 218. For example, the actuator(s) may move, deform, morph, and/or stretch the continuous projection surface 218 over the structure. Additionally, the actuator(s) may be configured to move, deform, morph, and/or stretch the continuous projection surface 218 over the structure. Note that the number, configuration, and position of the actuator(s) and structure may depend on the desired content and effect to be performed by the animatronic.

In some embodiments, actuators, motors, or any other mechanical means discussed herein may adjust and/or change the topography of the continuous projection surface 218 to a manipulated continuous projection surface (hereinafter “continuous projection surface”) 220, e.g., manipulated by moving or deforming the surface. For example, the continuous projection surface 218 may be manipulated to align with the content to be projected onto the continuous projection surface 220 and to enhance the movement effect, animating the continuous projection surface 220.

Additionally, content may be projected onto the continuous projection surface 220 (with an adjusted matching topography) as to animate the continuous projection surface 220 of the animatronic. For example, the continuous projection surface 220 of FIG. 2C is animated (topography changed and projected onto) to align with content that projects a mustache 222, wrinkles 224, and eyebrows 226 onto the continuous projection surface 220. The mustache 222, wrinkles 224, and eyebrows 226 may move corresponding to the desired content of the animatronic (e.g., move via the actuators). It should be understood that the continuous projection surface 220 may be animated to showcase a multitude of human or non-human facial features, expressions, emotions, motions, and other content of the sort that an animatronic is to perform or look like.

In some instances, a controller such as the controller 104 illustrated in FIG. 1 may receive data corresponding to the change in topography of the continuous projection surface 218 and/or continuous projection surface 220 (or data corresponding to the continuous projection surface 220 such as tracking data) and receive data corresponding to the content projected onto the continuous projection surface 220 (e.g., the mustache 222, the wrinkles 224, and the eyebrows 226). The controller may analyze the received data to align the movement of the actuators manipulating the continuous projection surface 220 with the content being projected onto the continuous projection surface 220. The controller may continuously analyze the received data to continuously align the movement of the actuators manipulating the continuous projection surface 220 with the content being projected onto the continuous projection surface 220.

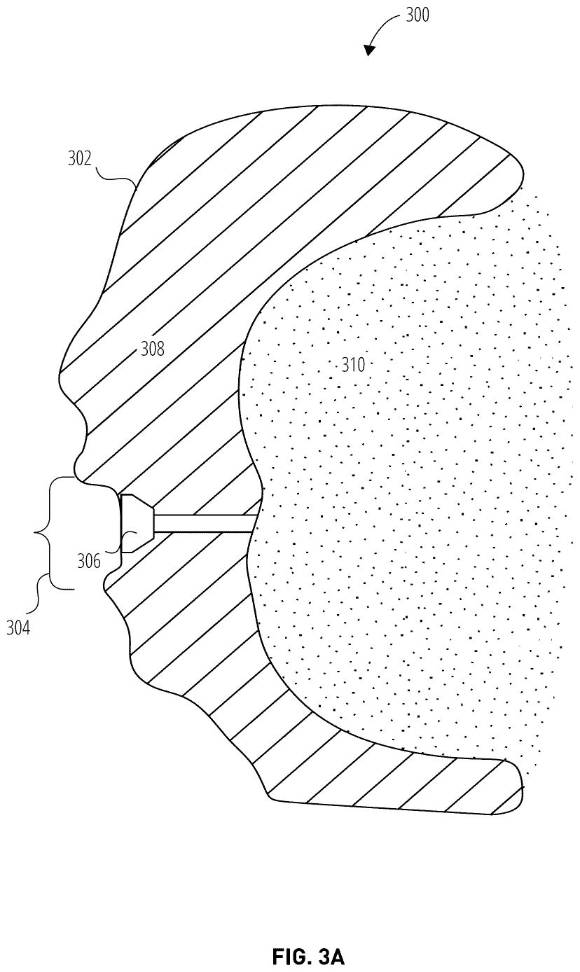

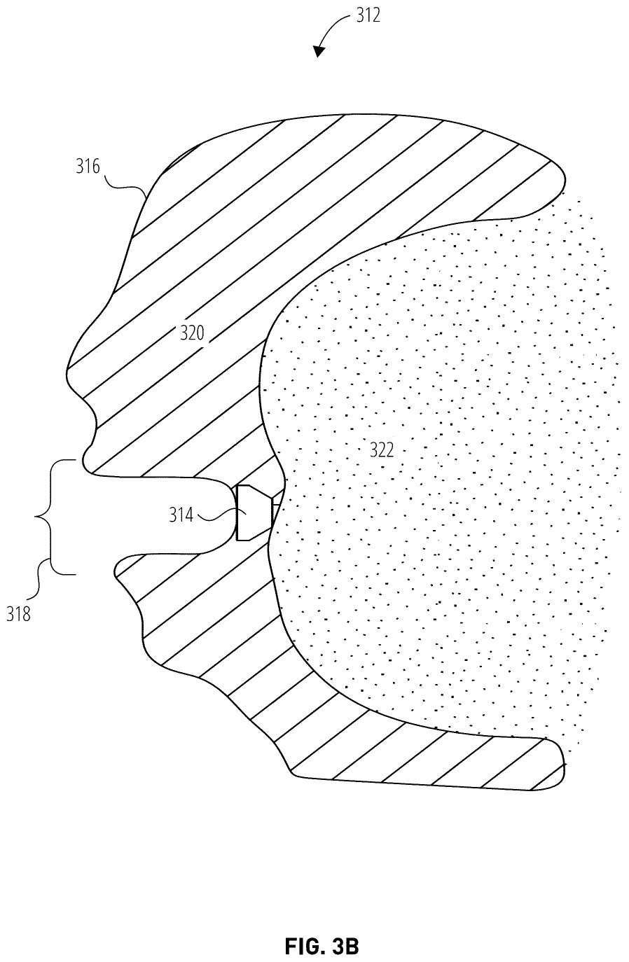

FIG. 3A illustrates a cross section side view 300 of a continuous projection surface 302 with an actuator 306 that is at rest.

The cross section side view 300 is a view of a cross section taken down the middle of the continuous projection surface 202 illustrated in FIG. 2A and rotated 90 degrees so that the front of the continuous projection surface 202 is facing to the left of the figure.

By way of example, the continuous projection surface 302 is coupled to a shell 310 (illustrated with a dot pattern) of an animatronic, as discussed herein. Between the continuous projection surface 302 and the shell 310 is space 308 (illustrated with crosshatching) where the continuous projection surface 302 may be deformed into (e.g., pulled back into) using an actuator or other mechanical means discussed herein, allowing an animatronic with the continuous projection surface 302 to showcase an emotion or content. The illustrated continuous projection surface 302 includes an actuator 306 that is coupled to a mouth recess 304, as discussed herein. The actuator 306 is at rest (e.g., not activated), not pulling or morphing the skin corresponding to the mouth recess 304 of the continuous projection surface 302. Note that the mouth recess 304 is not accentuated or overly morphed while the actuator 306 is at rest (e.g., not activated).

FIG. 3B illustrates a cross section side view 312 of a morphed continuous projection surface 316 with an activated actuator 314.

The cross section side view 312 is a view of a cross section taken down the middle of the continuous projection surface 210 illustrated in FIG. 2B and rotated 90 degrees so that the front of the continuous projection surface 210 is facing to the left of the figure.

By way of example, the morphed continuous projection surface 316 is coupled to a shell 322 (illustrated with a dot pattern) of an animatronic, as discussed herein. Between the morphed continuous projection surface 316 and the shell 322 is space 320 (illustrated with crosshatching) where the morphed continuous projection surface 316 is deformed into using an actuator or other mechanical means discussed herein. For example, the skin corresponding to the mouth recess 318 of the morphed continuous projection surface 316 is being pulled back into the space 320 between the morphed continuous projection surface 316 and the shell 322 by an actuator 314 that is activated. As a result, the mouth recess 318 is accentuated and morphed to look like a mouth. Note that the mouth recess 318 may be continuously morphed by the actuator 314 to animate the mouth recess 318 to perform content such as talking, eating, singing, etc.

While the mouth recess 318 of the morphed continuous projection surface 316 is illustrated, it should be understood that mechanical means discussed herein may be used to morph any portion of the continuous projection surface by either pulling skin of the continuous projection surface into the space 320 between the continuous projection surface and the shell 322 or by pushing excess skin out of the space 320 between the continuous projection surface and the shell 322. This pulling and pushing of the continuous projection surface may allow for the showcasing of an intended emotion or content on the animatronic with the continuous projection surface.

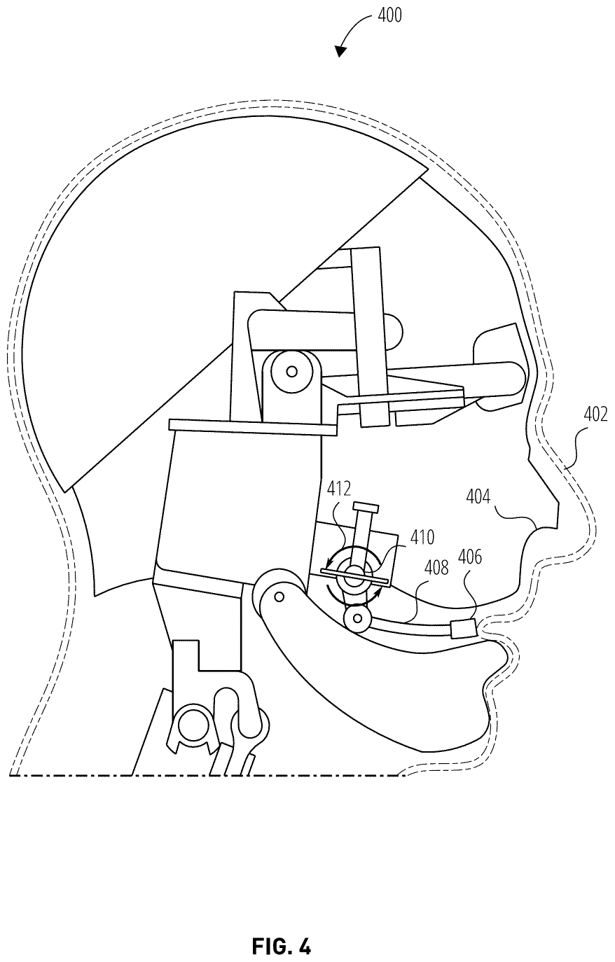

FIG. 4 illustrates a cross section side view 400 of a continuous projection surface 402 with example mechanical means for modifying the topography of the continuous projection surface 402.

The cross section side view 400 is a view of a cross section taken down the middle of the continuous projection surface 202 illustrated in FIG. 2A and rotated 90 degrees so that the front of the continuous projection surface 202 is facing to the right of the figure.

In various embodiments, the continuous projection surface 402 is coupled to (e.g., mechanically secured, adhesively connected, or the like) to a shell 404 of the animatronic. Additionally, a mouth portion of the continuous projection surface 402 is coupled or connected to a mechanical connection 406 that selectively varies the topography of the mouth portion. The mechanical connection 406 is coupled to a link 408, and the link 408 is coupled to a motor 410. As the motor 410 turns, the mechanical connection 406 coupled to the continuous projection surface 402 may move via the link 408. For example, as the motor 410 turns in a first direction (e.g., clockwise or a counterclockwise direction 412), the mechanical connection 406 pulls, via the link 408, the mouth portion of the continuous projection surface 402 inwardly (e.g., towards the motor 410) into the shell 404, such as to create a recess along the topography of the projection surface 402. In another example, as the motor 410 turns in a second direction (e.g., clockwise or the counterclockwise direction 412), the mechanical connection 406 pushes, via the link 408, the mouth portion of the continuous projection surface 402 outwardly (e.g., away from the motor 410, out of the shell 404, etc.), such as to reduce the recess along the topography of the projection surface 402. Turning the motor 410 in the second direction may result in the mouth portion returning to the starting/resting position, or protruding out of the shell 404. The movement of the motor 410 modifies the mouth portion of the continuous projection surface 402, allowing the mouth to move and mimic certain intended emotions (e.g., sad, happy, mad, etc.) and intended motions (e.g., talking, yelling, yawning, smiling, eating, etc.).

In some instances, the mouth portion of the continuous projection surface 402 may be understood as a mouth bag that, when moved and/or modified by the movement of the motor 410, may deform the topography of the continuous projection surface 402 to showcase a mouth and any motion and movement that may be performed by the mouth. In these examples, the mechanical action (e.g., forces) exerted by the mechanical coupling acts to change the topographical shape of the projection surface 402, such as to create a deeper recess or cavity to form an open mouth; to change a portion to create a tongue, teeth, or gumline, and/or to create differently shaped and sized openings in the mouth; to create a protrusion or bump in the projection surface (e.g., to mimic sticking out the tongue); etc. Because the projection surface 402 spans across an opening in the shell 404, the projection surface 402 can be pulled inwards to create the deeper recess, or can be pushed away from the shell to create a shallower or flat mouth portion. In many examples, the projection surface 402 defines an uninterrupted surface over the shell aperture or apertures (e.g., mouth openings or the like) that allows a more free form and bidirectional change of the topography of the projection surface 402. That is, the projection surface 402 can be deformed to be recessed and/or protruded from the same mechanical motion and shell support.

While in the illustrated example a motor 410 is used to modify the mouth portion of the continuous projection surface 402, it should be understood that any mechanical mechanisms, such as motors, links, and the like, including others as discussed herein may be connected to and used to morph or modify any portion of the continuous projection surface by either pulling skin of the continuous projection surface or by pushing excess skin of the continuous projection surface. Further, while in the illustrated example a link 408 is used to connect the mechanical connection 406 to the motor 410, any means of connecting the mechanical connection 406 to the motor 410 may be implemented (as discussed herein).

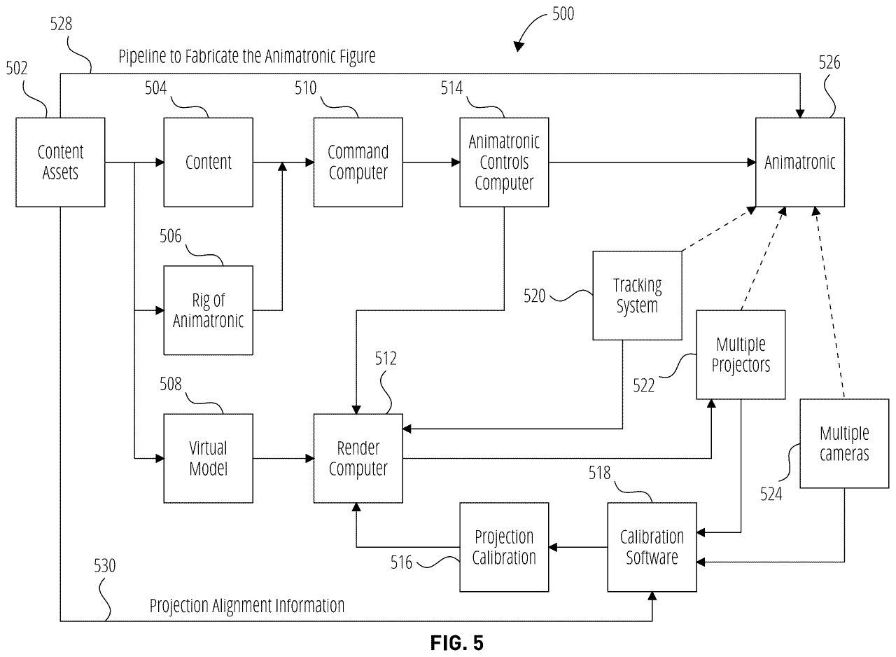

FIG. 5 is a system diagram 500 used for performing dynamic projection mapping onto animatronics. The system diagram 500 is an example implementation of the system 100 illustrated in FIG. 1.

The system diagram 500 begins with content assets 502 that may be stored on, for example, the server 102 illustrated in FIG. 1. The content assets 502 may be provided to an content 504 that is to be performed by the animatronic 526, and parameters corresponding to the rig of the animatronic 506 (e.g., mechanical measurements, torque values, rotational values, etc.). The content assets 502 may be provided to a virtual model 508 of the animatronic 526. In some instances, the content assets 502 may include data corresponding to a pipeline 528 used for fabricating the animatronic526 (e.g., parameters used to fabricate the animatronic 526). The animatronic 526 may be an example of the animatronic 106 illustrated in FIG. 1. In some examples, the virtual model 508 may include a virtual representation of the rig of the animatronic (e.g., including mechanical joints, mechanical components, and the kinematics of the rig) and any non-mechanical nodes of the animatronic.

The content 504 and the parameters corresponding to the rig of the animatronic 506 are provided to a command computer 510. The command computer 510 may be an example implementation of the controller 104 illustrated in FIG. 1. The command computer 510 may generate animatronic motion data based on the content 504 and the parameters corresponding to the rig of the animatronic 506. The command computer 510 may provide the animatronic motion data to a animatronic controls computer 514 that may encode the animatronic motion data onto the animatronic 526. The animatronic controls computer 514 may be an example implementation of the controller 104 illustrated in FIG. 1.

The animatronic 526 may perform the animatronic motion data based on actuators such as the actuator 110 (or other mechanical element). Note that the animatronic 526 includes the continuous projection surface (e.g., continuous projection surface 202 illustrated in FIG. 2A) which may have its topography changed by actuators such as the actuator 110 (or other mechanical elements), as discussed herein.

In addition, the animatronic controls computer 514 may provide the animatronic motion data to a render computer 512. The render computer 512 may be an example implementation of the controller 104 illustrated in FIG. 1. The render computer 512 may use the virtual model 508 and the animatronic motion data from the animatronic controls computer 514 to generate a projection that is to be projected onto the animatronic 526 by the one or more projectors 522 (hereinafter “multiple projectors 522”). The multiple projectors 522 may be example implementations of the projection system 108 illustrated in FIG. 1. It should be understood that the command computer 510, the render computer 512 and the animatronic control computer 514 may be implemented as one single computer (e.g., using one computer), or may be implemented in various combinations of computers (e.g., one computer for the command computer 510 and one computer for the joint implementation of the render computer 512 and the animatronic controls computer 514).

In some instances, the multiple projectors 522 may generate data corresponding to the projection (e.g., how aligned the content projected is with the movement of the animatronic) and transmit the generated data to the calibration software 518. Additionally, one or more cameras 524 (hereinafter “multiple cameras 524”) may track the animatronic 526 and the content projected onto the animatronic 526 to generate projection tracking data. The projection tracking data is provided to the calibration software 518. In some cases, the multiple cameras 524 may transmit the projection that is projected onto the animatronic 526 to the calibration software 518. In some examples, the calibration software 518 may receive projection alignment information 530 from the content assets 502 such as the content 504, the parameters corresponding to the rig of the animatronic 506, and the virtual model 508.

The calibration software 518 may run projection calibration 516 to calibrate the projection with the animatronic motion data (e.g., generated by the animatronic controls computer 514). The output of the projection calibration 516 may be provided to the render computer 512 (e.g., calibration parameters for the animatronic motion data and/or for the projection). In some examples, the render computer 512 may use the output of the projection calibration 516 to further generate (or modify) the projection that is to be projected onto the animatronic 526 by the multiple projectors 522. This may allow for better alignment between the movement of the animatronic 526 and the projection.

A tracking system 520 may track data of the animatronic 526 and the content projected onto the animatronic 526 according to various techniques discussed herein. For example, the tracking system 520 may use the sensors 112 illustrated in FIG. 1. The tracked data may include, for example, a pose of the animatronic 526, movement of the animatronic 526, distances from one or more objects in the scene around the animatronic 526, etc. The tracking system 520 may provide the tracked data to the render computer 512, and the render computer 512 may use the tracked data from the tracking system 520 to further generate (or modify) the projection that is projected onto the animatronic 526. In some cases, the tracking system 520 may track how aligned the content projected onto the animatronic 526 is with the movements performed by the animatronic 526 (e.g., from the perspective of the multiple projectors 522).

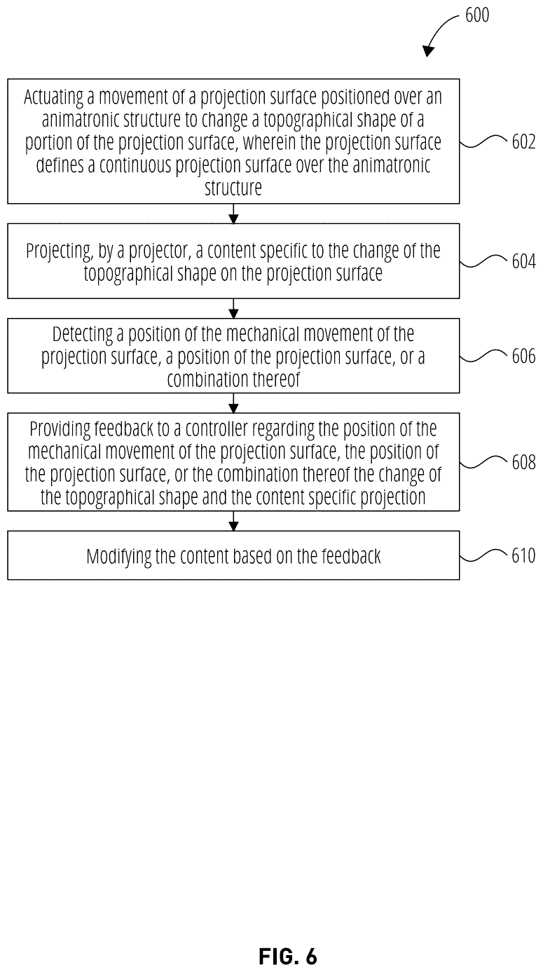

FIG. 6 illustrates a method 600 of activating an animatronic. The illustrated method 600 includes actuating 602 a movement of a projection surface positioned over an animatronic structure (e.g., shell) to change a topographical shape of a portion of the projection surface, wherein the projection surface defines a continuous projection surface over the animatronic structure. For example, actuators, motors, links, or any other mechanical means may change the topographical shape of the projection surface. In some cases, mechanical movement may deform the animatronic structure that the projection surface is wrapped around, morphing the topographical shape to align with content that is projected onto the projection surface. In some embodiments, the animatronic structure defines a recess or aperture and the projection surface extends over the recess or aperture to cover the recess or aperture.

The method 600 further includes projecting 604, by a projector, a content specific to the change of the topographical shape on the projection surface. For example, a specific facial expression conveying a specific emotion may be projected onto the continuous projection surface, which has had its topography adjusted to align with the facial expression projected onto it. In some examples, the actuating 602 is contemporaneous with the projecting 604.

The method 600 further includes detecting 606 a position of the mechanical movement of the projection surface, a position of the projection surface, or a combination thereof. For example, the tracking of the animatronic may be performed to detect a position of the mechanical movement of the projection surface.

The method 600 further includes providing 608 feedback to a controller regarding the position of the mechanical movement of the projection surface, the position of the projection surface, or the combination thereof the change of the topographical shape of the projection surface, and the content. For example, tracking of the animatronic may be performed to determine a pose or orientation of the animatronic. Data corresponding to the tracking of the animatronic may be passed to the controller to further align the topographical shape and content specification projection.

The method 600 further includes modifying 610 the content based on the feedback. For example, the content may be modified to align better with the topography of the projection surface producing more realistic expressions and emotions for the animatronic.

In some embodiments, the method 600 further comprises aligning the projection surface with the projector based on the feedback.

In some embodiments of the method 600, the feedback comprises feedback intrinsic to the animatronic, feedback external to the animatronic, or a combination thereof.

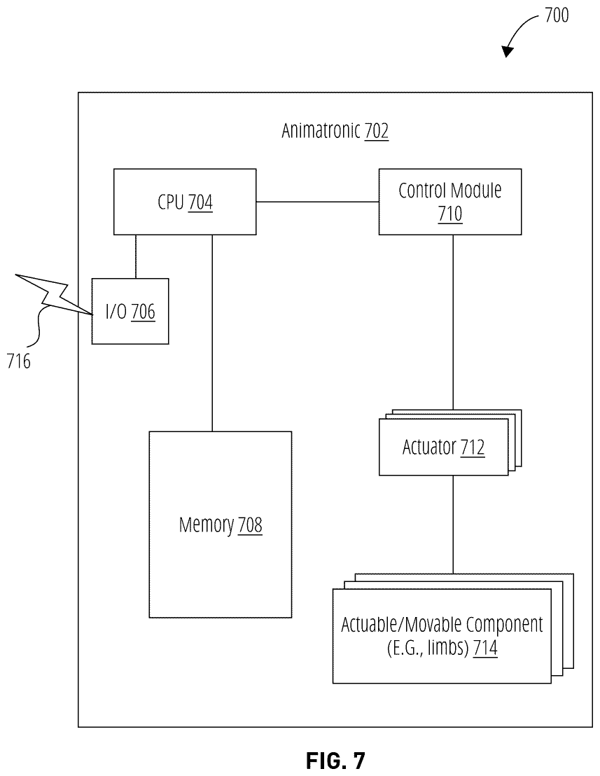

FIG. 7 illustrates a functional block diagram of an animatronic design system 700 of an animatronic 702 operable or controllable according to the hybrid approach discussed herein. For example, the hybrid approach discussed herein may provide intended movements and emotions to be performed by the animatronic 702 to achieve an intended effect of an attraction. The movements and emotions (and artistic characteristics) are provided to an animatronic 702 in a wired or wireless manner as shown with arrows 716. After providing, the animatronic 702 becomes an actor with the capability to perform a role that tells a story through motion and emotion. The control policies may be a script, instructions, or mode.

The animatronic 702 may take a wide variety of forms to practice the content. In some instances, the animatronic 702 may include a pelvis, a torso, and a head, but these are not required. Further, the animatronic 702 will include one or more actuators 712 (or drivers) selectively operated by a control module 710 to actuate or drive one or more movable components 714 such as limbs with (or without) feet, arms with (or without) hands, and so on. Examples generally encompass content for a two-legged or four-legged animatronic 702, but this is not a limitation as the concepts are equally applicable to other movable components of an animatronic.

The animatronic 702 includes a processor 704 managing operations of I/O devices 706 (e.g., user device, joy-stick controller, keyboard, mouse, etc.), which are used at least to receive communications such as from a design station, which may be an ordinary personal computer (PC) workstation, laptop, or the like using software tools described in the following paragraphs. Particularly, the animatronic 702 also includes memory 708 or data storage devices for storing the content received from, for example, a server or computer where the content is generated and/or stored.

The processor 704 runs software and/or executes code/instructions (e.g., in memory 708) to provide the functionality of a control module 710. The control module 710 may be configured to include one or more artificial intelligence (AI) components and to otherwise adapt to current conditions for the animatronic 702. For example, the control module 710 may control the animatronic 702 (e.g., via control signals to the actuators 712) based on the motions in the content.

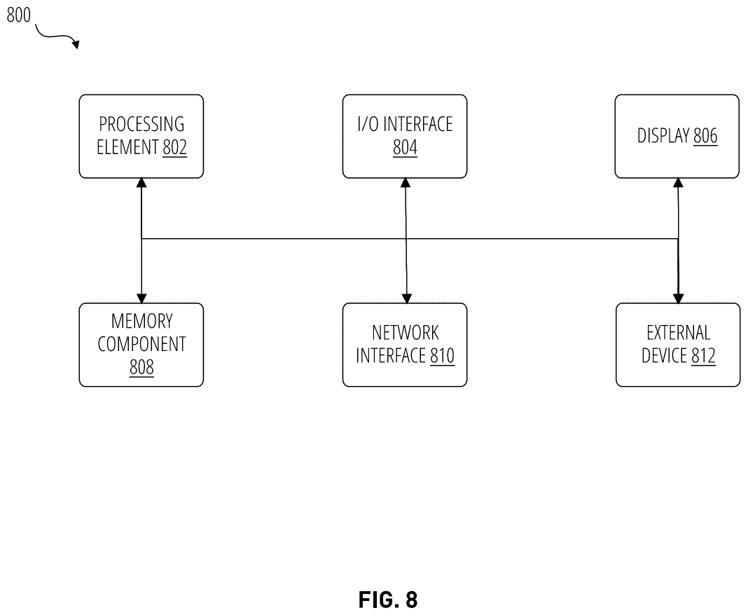

FIG. 8 is a simplified block diagram of components of a computing system 800 of the system 100, such as the server 102, the controller 104 etc. For example, the processing element 802 and the memory component 808 may be located at one or in several computing systems 800. This disclosure contemplates any suitable number of such computing systems 800. For example, the server 102 may be a desktop computing system, a mainframe, a blade, a mesh of computing systems 800, a laptop or notebook computing system 800, a tablet computing system 800, an embedded computing system 800, a system-on-chip, a single-board computing system 800, or a combination of two or more of these. Where appropriate, a computing system 800 may include one or more computing systems 800; be unitary or distributed; span multiple locations; span multiple machines; span multiple data centers; or reside in a cloud, which may include one or more cloud components in one or more networks. A computing system 800 may include one or more processing elements 802, an input/output I/O interface 804, one or more external devices 812, one or more memory components 808, and a network interface 810. Each of the various components may be in communication with one another through one or more buses or communication networks, such as wired or wireless networks, e.g., the controller 104. The components in FIG. 8 are exemplary only. In various examples, the computing system 800 may include additional components and/or functionality not shown in FIG. 8.

The processing element 802 may be any type of electronic device capable of processing, receiving, and/or transmitting instructions. For example, the processing element 802 may be a central processing unit, microprocessor, processor, or microcontroller. Additionally, it should be noted that some components of the computing system 800 may be controlled by a first processing element 802 and other components may be controlled by a second processing element 802, where the first and second processing elements may or may not be in communication with each other.

The I/O interface 804 allows a user to enter data in to computing system 800, as well as provides an input/output for the computing system 800 to communicate with other devices or services. The I/O interface 804 can include one or more input buttons, touch pads, touch screens, and so on.

The external device 812 are one or more devices that can be used to provide various inputs to the computing systems 800, e.g., mouse, microphone, keyboard, trackpad, sensing element (e.g., a thermistor, humidity sensor, light detector, etc. The external devices 812 may be local or remote and may vary as desired. In some examples, the external devices 812 may also include one or more additional sensors.

The memory components 808 are used by the computing system 800 to store instructions for the processing element 802, as well as store data. The memory components 808 may be, for example, magneto-optical storage, read-only memory, random access memory, erasable programmable memory, flash memory, or a combination of one or more types of memory components.

The network interface 810 provides communication to and from the computing system 800 to other devices. The network interface 810 includes one or more communication protocols, such as, but not limited to Wi-Fi, Ethernet, Bluetooth, etc. The network interface 810 may also include one or more hardwired components, such as a Universal Serial Bus (USB) cable, or the like. The configuration of the network interface 810 depends on the types of communication desired and may be modified to communicate via Wi-Fi, Bluetooth, etc.

The display 806 provides a visual output for the computing system 800 and may be varied as needed based on the device. The display 806 may be configured to provide visual feedback and may include a liquid crystal display screen, light emitting diode screen, plasma screen, or the like. In some examples, the display 806 may be configured to act as an input element through touch feedback or the like.

The computing system 800 may be include a physical device or separate physical devices including components to read and execute instructions from a machine-readable or computer-readable medium (e.g., a non-transitory machine-readable storage medium).

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. While the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A robotic system comprising:
a continuous projection surface coupled to a structure;
an actuator coupled to the structure and configured to change a topography of a portion of the continuous projection surface; and
a projector positioned relative to the continuous projection surface and configured to project content onto the continuous projection surface.

2. The robotic system of claim 1, wherein the structure defines a recess and the continuous projection surface extends over the recess to define a projection area over the recess.

3. The robotic system of claim 2, wherein the actuator moves the structure to cause the continuous projection surface to define a concave section for the projection area over the recess.

4. The robotic system of claim 1, wherein the actuator is configured to expand the portion of the structure and the continuous projection surface extends over the portion to enable definition of a projection area over the portion.

5. The robotic system of claim 1, wherein:
the projector is spatially aligned with the continuous projection surface such that the content is aligned with changes in the topography as the actuator moves the continuous projection surface; and
the content is time aligned with the actuator such that the actuator moves the topography based on the content.

6. The robotic system of claim 1, further comprising a sensor in communication with the projector and configured to detect a position of the actuator or the continuous projection surface.

7. The robotic system of claim 6, further comprising a controller, wherein the sensor is in communication with the projector via the controller.

8. The robotic system of claim 6, wherein the sensor is external to the structure.

9. The robotic system of claim 6, wherein the sensor is internal to the structure.

10. The robotic system of claim 1, wherein the actuator is configured to move the continuous projection surface to generate a first type of output and the projector projects content to generate a second type of output, wherein the first type of output and the second type of output together generate a robotic device output.

11. The robotic system of claim 10, further comprising a scenic element, wherein the scenic element enhances the robotic device output.

12. The robotic system of claim 10, further comprising a sound element, wherein the sound element enhances the robotic device output.

13. A method of activating a robot comprising:
actuating a mechanical movement of a projection surface positioned over an robotic structure to change a topographical shape of a portion of the projection surface, wherein the projection surface defines a continuous projection surface over the robotic structure;
projecting, by a projector, a content specific to the change of the topographical shape on the projection surface;
detecting a position of the mechanical movement of the projection surface, a position of the projection surface, or a combination thereof;
providing feedback to a controller regarding the position of the mechanical movement of the projection surface, the position of the projection surface, or the combination thereof, the change of the topographical shape, and the content; and
modifying the content based on the feedback.

14. The method of claim 13, further comprising:
aligning the projection surface with the projector based on the feedback.

15. The method of claim 13, wherein the feedback comprises feedback intrinsic to the robot, feedback external to the robot, or a combination thereof.

16. The method of claim 13, wherein the robotic structure defines a recess or aperture, and the projection surface extends over the recess or aperture to cover the recess or aperture.

17. A non-transitory computer-readable media comprising instructions to cause a robot to:
actuate a mechanical movement of a mouth feature of a projection surface positioned over a robotic structure to change a topographical shape of the mouth feature of the projection surface, wherein the projection surface defines a continuous projection surface over the robotic structure;
project, by a projector, a content specific to the change of the topographical shape on the mouth feature of the projection surface;
detect a position of the mouth feature of the projection surface;
provide feedback to a controller regarding the position of the mouth feature of the projection surface, the change of the topographical shape and the content; and
modify the content based on the feedback.

18. The non-transitory computer-readable media of claim 17, wherein the instructions further cause the robot to align the mouth feature of the projection surface with the projector based on the feedback.

19. The non-transitory computer-readable media of claim 17, wherein the feedback comprises feedback intrinsic to the robot, feedback external to the robot, or a combination thereof.

20. The non-transitory computer-readable media of claim 17, wherein the robotic structure defines a recess or aperture, and the projection surface extends over the recess or aperture to cover the recess or aperture.
